(19) United States
(12) Patent Application Publication
(10) Pub. No.: US 2025/0229404 A1
(43) Pub. Date: Jul. 17, 2025

(54) WORK MACHINE

(71) Applicant: Koki Holdings Co., Ltd., Tokyo (JP)

(72) Inventors: Daisuke NEMOTO, Ibaraki (JP); Kenichirou YOSHIDA, Ibaraki (JP); Tetsuya MONZEN, Ibaraki (JP)

(21) Appl. No.: 18/875,439

(22) PCT Filed: May 26, 2023
(86) PCT No.: PCT/JP2023/019605

§ 371 Date: Dec. 16, 2024

(30) Foreign Application Priority Data
Jun. 16, 2022 (JP) 2022-097596

(51) Int. Cl. B25F 5/02; B25F 5/00

(52) U.S. Cl. CPC B25F 5/02; B25F 5/006

(57) ABSTRACT

Workability of a work machine is improved. A work machine includes: a motor portion including an electric motor; a battery pack for supplying power to the electric motor; a mount part mounted with the battery pack; a drive part connected to the motor; a cover covering the drive part; an output shaft supported by the drive part; a tip tool attached to a tip of the output shaft; and a housing accommodating the motor. In the work machine, the drive part and the cover are connected via a U-shaped elastic member, and the motor portion and the housing are connected not via an elastic body.

### TECHNICAL FIELD

The present invention relates to a work machine.

### BACKGROUND ART

As an example of a work machine, a work machine including: an electric motor; a drive part being connected to the motor; a housing accommodating the motor; and a tip tool being operated by a drive force of the motor is known.

As the work machine such as described above, for example, a Patent Document 1 discloses a work machine that performs processing by right/left vibration (reciprocation) of the tip tool attached to an output shaft of the drive part.

### RELATED ART DOCUMENT

### Patent Document

Patent Document 1: Japanese Patent Application Laid-Open Publication No. 2015-127075

### SUMMARY OF THE INVENTION

### Problems to be Solved by the Invention

In the work machine described in the Patent Document 1 described above, an operator performs the processing while holding a portion of the housing, vibration (oscillation) is propagated from the drive part to the housing, and the housing is largely vibrated. As a result, vibration propagated to the operator also increases to cause a reduction in workability.

Therefore, it has been desired to reduce the vibration propagated to the operator during the processing for improving the workability of the work machine.

An objective of the present invention is to provide a work machine with improved workability.

### Means for Solving the Problems

A work machine of the present invention includes: a motor; a drive part connected to the motor; an output shaft supported by the drive part; and a housing accommodating the motor, and the drive part and the housing are connected via an elastic body while the motor and the housing are connected not via the elastic body, or the drive part and the housing are connected not via the elastic body, and the motor and the housing are connected via the elastic body.

### Effects of the Invention

According to the present invention, workability of a work machine can be improved.

### BRIEF DESCRIPTIONS OF THE DRAWINGS

FIG. 1 is a cross-sectional view of a side surface showing a structure of a work machine of a first embodiment of the present invention;

FIG. 2 is a cross-sectional view showing an arrangement structure of an elastic body in the work machine in FIG. 1;

FIG. 3 is a perspective view showing a structure of the elastic body assembled in the work machine in FIG. 1;

FIG. 4 is a partial perspective view showing a structure of a drive part to be fitted with the elastic body in FIG. 3;

FIG. 5 is a partial perspective view showing a fitted state of the elastic body on the drive part in FIG. 4;

FIG. 6 is a cross-sectional perspective view showing a structure in FIG. 5 cut through horizontally;

FIG. 7 is a cross-sectional view showing a structure of a work machine of a first modification example of the embodiment of the present invention;

FIG. 8 is a cross-sectional view showing an arrangement structure and the like of an elastic body in the work machine in FIG. 7;

FIG. 9 is a cross-sectional view A-A in FIG. 8;

FIG. 10 is a perspective view showing a structure of a rear extending portion of the work machine in FIG. 9;

FIG. 11 is a cross-sectional perspective view showing the rear extending portion in FIG. 10 cut through vertically;

FIG. 12 is a cross-sectional perspective view showing the rear extending portion in FIG. 10 cut through horizontally;

FIG. 13 is a cross-sectional view showing an arrangement structure of an elastic body in a work machine of a second modification example of the embodiment of the present invention;

FIG. 14 is a perspective view showing a structure of a rear extending portion of the work machine in FIG. 13;

FIG. 15 is a cross-sectional perspective view showing the rear extending portion in FIG. 14 cut through vertically;

FIG. 16 is a cross-sectional perspective view showing the rear extending portion in FIG. 14 cut through horizontally;

FIG. 17 is a cross-sectional view showing an arrangement structure of an elastic body in a work machine of a third modification example of the embodiment of the present invention;

FIG. 18 is a perspective view showing a structure of a rear extending portion of the work machine in FIG. 17;

FIG. 19 is a cross-sectional perspective view showing the rear extending portion in FIG. 18 cut through vertically; and

FIG. 20 is a cross-sectional perspective view showing the rear extending portion in FIG. 18 cut through horizontally.

### DETAILED DESCRIPTION OF PREFERRED EMBODIMENTS

The embodiments of the present invention will be described in detail below with reference to the drawings. In the plurality of drawings used for describing each embodiment, the same components are denoted by the same reference symbols. As an example of a work machine in the present embodiment, an electric work machine that drives a tip tool by using an electric motor will be described.

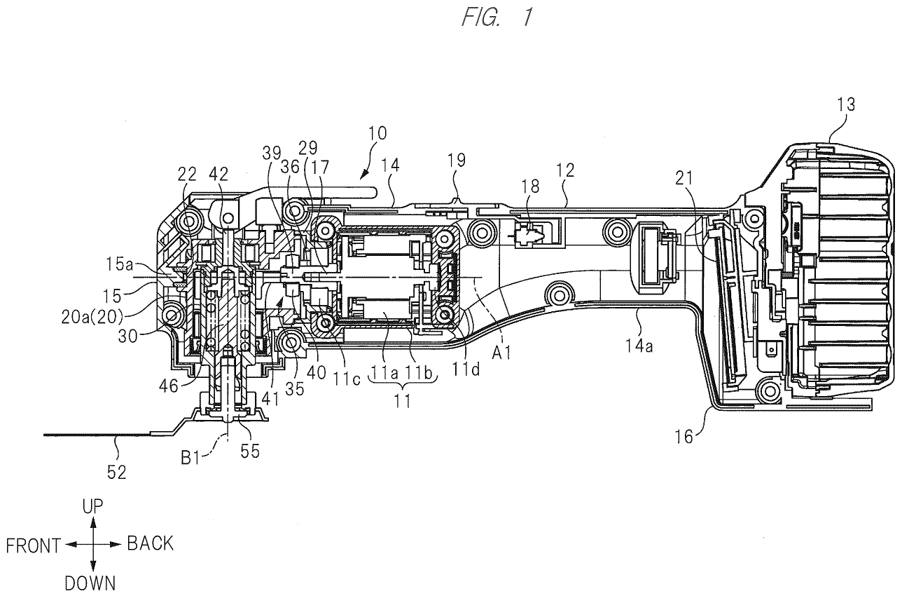

A work machine 10 shown in FIG. 1, which is also called a multitool or the like, has a machine body 12 accommodating a motor portion 11 (an electric motor 11a and a motor case 11b), and a battery pack 13 supplying electric power to the electric motor 11a. The battery pack 13 is detachable to the machine body 12. The work machine 10 is a cordless type where the machine body 12 is not provided with a power cord to be connected to a utility power outlet (socket). In addition, in cross-sectional views, a member is hatched to clearly show its positional relationship.

The machine body 12 has a housing (an outer housing) 14 through which a first axis A1 passes (which extends in a direction of the first axis A1), and a cover (a housing, an outer housing) 15 arranged at one end (a front end) of the housing 14 in a direction along the first axis A1. The housing 14 and the cover 15 are integrated (to be a continuous single member), and the cover 15 covers a drive part (a head part) 20 connected to the motor 11. That is, a portion of the housing closer to the front side than the motor portion 11 is the cover 15. The motor portion 11 and the drive part 20 are integrally connected by a fixing element such as a screw. The housing 14 is tubular, and has a mount part 16. The mount part 16 is provided on an opposite side of an end provided with the cover 15 in the direction along the first axis A1. The battery pack 13 is attached to and detached from the mount part 16. The housing 14 is provided with a grip part 14a having a smaller diameter than that of a portion housing the electric motor 11a. The operator can work while holding the grip part 14a. The housing 14 and the cover 15 are integrated (to be a continuous signal member), but are configured to be dividable in the right-left direction. In addition, the housing 14 and the cover 15 are made of resin. In addition, although not illustrated, outer surfaces of the housing 14 and the cover 15 (mainly around the grip part 14a) are provided with an elastic portion (elastomer) by integral molding in order to enhance grip power. A technique of integrally molding the elastic portion (elastomer) with the housing made of resin is a well-known technique. The electric motor 11a, which is a power source, is provided in the housing 14 while being housed in the motor case 11b. The electric motor 11a has a motor shaft 17. A main switch 18 is provided in the housing 14, and a slide switch 19 operated by the operator is provided on an outer wall of the housing 14 (in front of the grip part 14a). The slide switch 19 is movable along the housing 14, and can turn on/off the main switch 18 when moving. Further, a controller 21 is provided in the housing 14. The controller 21 is a publicly-known microcomputer including a drive part circuit, an arithmetic part, a storage part, an input port, an output port, and the like.

In addition, a holder 29 made of synthetic resin is provided in the housing 14 (the cover 15). The holder 29 has a front end connected to a rear end portion 11d of a drive part case described later, and the motor shaft 17 is rotatably supported by the holder 29 via a bearing 11c.

In addition, the drive part 20 is accommodated in the cover 15. The drive part 20 includes a drive part case 20a, and an output shaft 30 is supported by (housed in) the drive part case 20a. The drive part case 20a is made of metal. The output shaft 30 is tubular, and is supported by the drive part case 20a so as not to move in a direction along a second axis B1.

In addition, a power transmission mechanism 35 is provided in the drive part case 20a. The power transmission mechanism 35 is a mechanism for converting a rotational force of the motor shaft 17 into a force reciprocating the output shaft 30 within a predetermined angular range. The power transmission mechanism 35 includes a spindle 36 rotating integrally with the motor shaft 17. This spindle 36 is provided concentrically with the motor shaft 17. A central line of the spindle 36 is coaxial with the first axis A1 of the motor shaft 17, and the spindle 36 is provided with an eccentric shaft 39. A central line of the eccentric shaft 39 is arranged at a position eccentric from the first axis A1. An inner ring of a ball bearing 40 is attached to an outer circumferential surface of the eccentric shaft 39.

A swing arm 41 linking an outer ring of the ball bearing 40 and the output shaft 30 together is provided. The swing arm 41 is fixed to the output shaft 30. The swing arm 41 is shaped to have a U-shape including a pair of arm portions extending in parallel to the motor shaft 17. The pair of arm portions are arranged at a distance therebetween equal to an outer diameter of the outer ring of the ball bearing 40. The pair of arm portions are in contact with the outer ring of the ball bearing 40. That is, the outer ring of the ball bearing 40 is sandwiched between the pair of arm portions.

In addition, the drive part 20 has a first shaft 42 provided in the drive part case 20a and being movable in a direction along the second axis B1. Further, the drive part 20 has a second shaft 46 arranged in the output shaft 30. One end of the second shaft 46 in the direction along the second axis B1 is fixed to the first shaft 42. Therefore, the first shaft 42 and the second shaft 46 are integrally movable in the direction along the second axis B1. That is, the first shaft 42 and the second shaft 46 are movable in a longitudinal direction.

In addition, an end of the second shaft 46 is provided with a tool fixing member 55, and a tip tool 52 is mounted on the output shaft 30 by clamping the tip tool 52 by the tool fixing member 55 and the output shaft 30. Note that the detachable structure of the tip tool 52 according to the present embodiment is similar to that described in the related-art document, and accordingly will not be described in more detail.

And, in the work machine 10, when the operator operates the slide switch 19 to turn on the main switch 18 while the battery pack 13 is attached to the mount part 16, the power of the battery pack 13 is supplied to the electric motor 11a through the controller 21, and the motor shaft 17 of the electric motor 11a rotates. On the other hand, when the operator operates the slide switch 19 to turn off the main switch 18, the power of the battery pack 13 is not supplied to the electric motor 11a anymore, and the motor shaft 17 of the electric motor 11a stops.

In the work machine 10, when the power is supplied to the electric motor 11a to rotate the motor shaft 17 in one direction, the motor shaft 17 and the spindle 36 rotate integrally. By the rotation of the spindle 36, the eccentric shaft 39 and the ball bearing 40 are revolved around the first axis A1. By the revolution of the ball bearing 40 around the first axis A1, the swing arm 41 is reciprocated (swung) within a predetermined angular range while taking the output shaft 30 as a pivot point. Therefore, the output shaft 30 repeats forward rotation and backward rotation around the second axis B1 alternately within a predetermined angular range. In this manner, a rotational force of the electric motor 11a is converted into a rotational force (vibrational force) of the output shaft 30.

By the forward rotation and backward rotation of the output shaft 30 within the predetermined angular range, the tip tool 52 is also rotated around the second axis B1 within a predetermined angular range. And, by pressing the tip tool 52 against a workpiece, the workpiece can be processed, for example, be cut and/or polished.

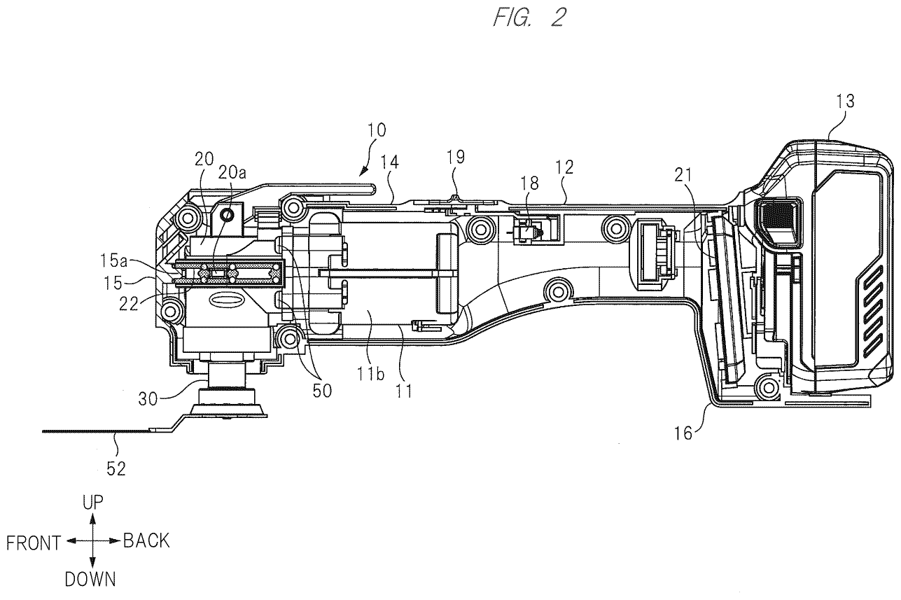

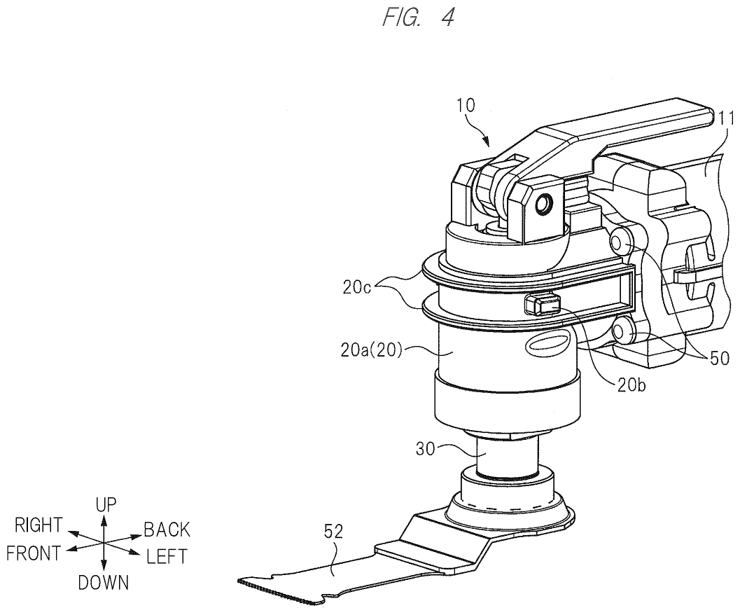

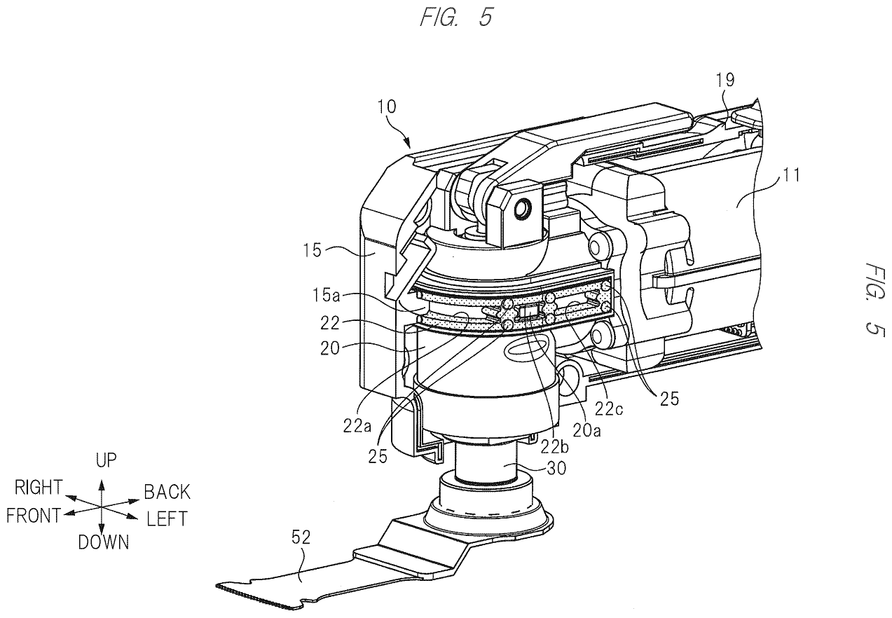

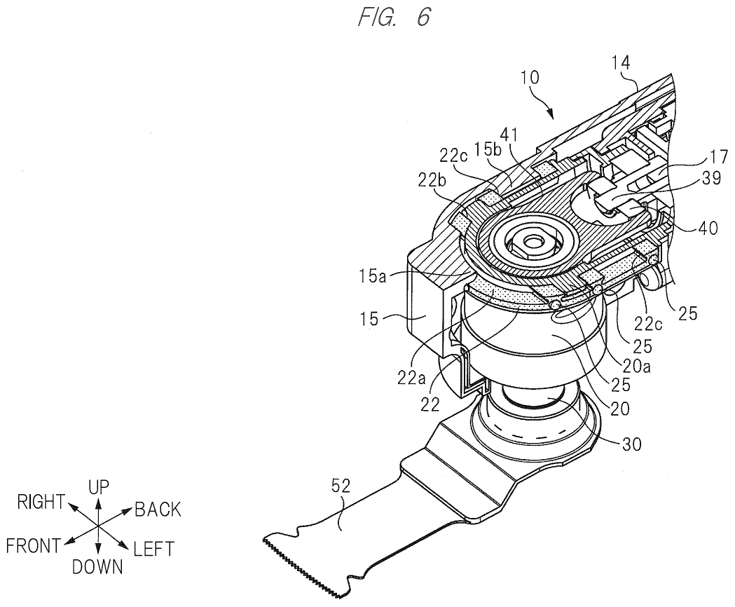

Next, a countermeasure against the vibration of the work machine 10 of the present embodiment will be described. In the work machine 10, the motor portion 11 and the drive part 20 are integrally connected by the fixing element 50 such as a screw. That is, the motor portion 11 and the drive part 20, which are each configured as a separate member, are integrated, and are supported as an inner part (drive unit) by the outer housing (the housing 14, the cover 15). Therefore, in the work machine 10, the motor portion 11 and the drive part 20 vibrate integrally during the operation. Accordingly, it is necessary to consider reduction in the vibration propagated to the operator. Regarding the vibration, in the case of such a configuration as the present embodiment, right/left vibration is generated due to the right/left reciprocation of the output shaft 30 and the swing arm 41. In addition, the swing arm 41 vibrates rightward/leftward around the second axis B1, and therefore, front/rear motion is also generated (particularly at a rear end portion), and front/rear vibration is also generated by this motion. The vibration in the up-down direction is small than the vibrations in the right-left direction and the front-rear direction. Regarding the vibration, an elastic body (damper) may be arranged between a source of the vibration and a hand of the operator (the grip part 14a). However, since the source of vibration is movable relative to the grip part 14a (the housing 14), it is important how to regulate the relative movement while damping the vibration. In addition, an amplitude amount of the source of vibration may be different depending on a location. In the work machine 10 of the present embodiment, as shown in FIG. 2, the drive part 20 and the cover 15 are connected via an elastic body. In other words, the drive part 20 (the drive part case 20a) is supported by the cover 15 (the outer housing) via the elastic body. Further, the motor portion 11 and the housing 14 are configured not to have an elastic body therebetween. That is, there is a gap between the motor portion 11 and the housing 14 (that is, the motor portion 11 and the housing 14 are separated from each other). In more detail, an outer surface of the motor portion 11 (the motor case 11b) is not in contact with the housing 14. The present embodiment will be described in a case where the elastic body is a U-shaped elastic member 22 as an example of the elastic body. That is, the drive part 20 and the cover 15 are connected via the U-shaped elastic member 22. Note that other portions than cross sections in the U-shaped elastic member 22 are hatched in order to support understanding for a positional relationship. As shown in FIG. 4, the drive part 20 (the drive part case 20a) is shaped to have a substantially tubular shape, and is provided with the U-shaped elastic member 22 along an outer circumferential portion of the tubular drive part 20. In other words, as shown in FIGS. 5 and 6, the U-shaped elastic member 22 is arranged to surround the outer circumferential portion of the tubular drive part 20. On the other hand, the motor portion 11 (the electric motor 11a) is connected to the housing 14 not via an elastic body (is separated from the outer housing). Note that the elastic body (damper) as described in the present application refers to a material having a property of being deformed by an external force and being restored if the external force is removed. The elastic body is, for example, rubber, urethane, sponge, spring, or the like.

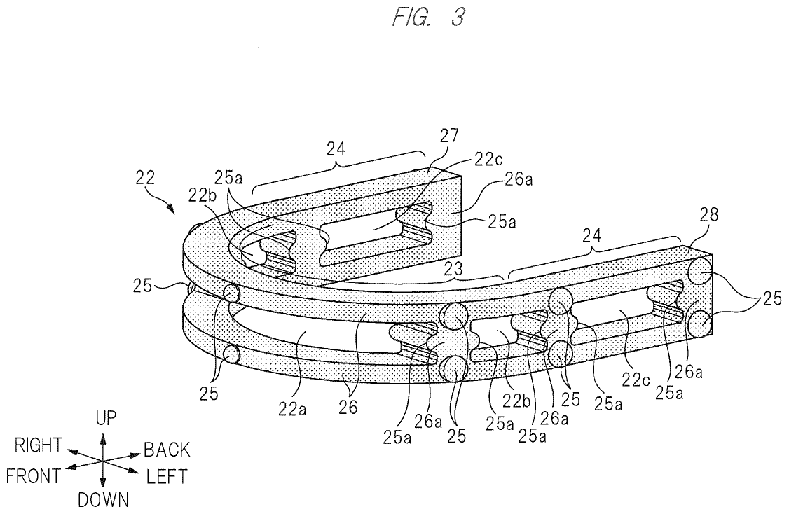

The U-shaped elastic member 22 assembled to the work machine 10 will be described here. The U-shaped elastic member 22 is an elastic body made of rubber or the like, and includes a first elastic body 23 and a second elastic body 24 arranged at different positions in a direction crossing the right-left direction as shown in FIG. 3. Specifically, the U-shaped elastic member 22 includes the first elastic body 23 and the second elastic body 24 arranged at the positions that are different from each other in the direction (the front-rear direction or the up-down direction) crossing the right-left direction. The first elastic body 23 is a curved portion of the U-shaped elastic member 22, and the second elastic body 24 is a substantially linear portion of the U-shaped elastic member 22. At least in the front-rear direction, the first elastic body 23 and the second elastic body 24 are arranged at the different positions from each other. That is, as the vibration damping mechanism connected to the drive part 20, the present embodiment includes the first elastic body 23 and the second elastic body 24 arranged at the different positions in the direction crossing the right-left direction.

In addition, the U-shaped elastic member 22 includes a left elastic body 28 arranged on a left side of the drive part 20, and a right elastic body 27 arranged on a right side of the drive part 20, and the left elastic body 28 and the right elastic body 27 in the U-shaped elastic member 22 are integrated.

Further, either one of the first elastic body 23 and the second elastic body 24 includes a protruding portion (a first elastic portion) 25 connected to either one of the cover 15 and the drive part 20 and having a first elastic modulus, and a base portion (a second elastic portion) 26 connected to the other of the cover 15 and the drive part 20 and having a second elastic modulus higher than the first elastic modulus. The U-shaped elastic member 22 is specifically provided with the parallel upper and lower U-shaped base portions 26 and with the outward-protruding protruding portions 25 at a plurality of positions of respective outer circumferential portions of the U-shaped base portions 26. The plurality of protruding portions 25 each have a small area, and therefore, have a low elastic modulus. That is, in assumption that the elastic modulus of the protruding portion 25 is a first elastic modulus while the elastic modulus of the base portion 26 is a second elastic modulus, a relationship of “the first elastic modulus<the second elastic modulus” is established such that the protruding portion 25 is softer than the base portion 26. In other words, the base portion 26 is harder than the protruding portion 25.

In addition, the U-shape elastic member 22 has linking portions 26a linking the two parallel upper and lower base portions 26 in the up-down direction, and has, as opening portions, a first opening portion 22a, a second opening portion 22b, and a third opening portion 22c to be surrounded by the base portions 26 and the linking portions 26a. The first opening portion 22a and the second opening portion 22b are provided substantially corresponding to the region of the first elastic body 23, and the third opening portion 22c is provided substantially corresponding to the region of the second elastic body 24. Further, a gap between the two parallel base portions 26 includes inner protruding portions 25a protruding from the linking portions 26a into each of the first opening portion 22a, the second opening portion 22b, and the third opening portion 22c.

As shown in FIGS. 5 and 6, the U-shaped elastic member 22 formed in the shape described above is arranged to surround the out circumferential portion of the tubular drive part 20. Therefore, in the work machine 10, the U-shaped elastic member 22 has respective portions on the left side, the right side, and the front side of the drive part 20. As shown in FIG. 4, upper and lower projecting flange portions 20c are provided in parallel on the outer circumferential portion of the tubular drive part 20. Further, a gap between the upper and lower flange portions 20c on two lines on the outer circumferential portion of the drive part 20 includes protruding portions 20b protruding in right-left directions. And, as shown in FIG. 5, the U-shaped elastic member 22 is fitted into the gap between the upper and lower flange portions 20c on two lines. At this time, the protruding portion 20b of the drive portion 20 is fitted into the second opening portion 22b of the U-shaped elastic member 22.

In addition, the first elastic body 23, which is a curved portion of the U-shaped elastic member 22, is located between the drive part 20 and the cover 15 in the front-rear direction. Further, the right elastic body 27 of the U-shape elastic member 22 is located between the drive part 20 and the cover 15 on the right side of the drive part 20 in the right-left direction. On the other hand, the left elastic body 28 of the U-shape elastic member 22 is located between the drive part 20 and the cover 15 on the left side of the drive part 20 in the right-left direction. And, as shown in FIG. 6, a front rib 15a of the cover 15 is fitted into the first opening portion 22a of the U-shaped elastic member 22, and a side rib 15b of the cover 15 is fitted into the third opening portion 22c of the U-shaped elastic member 22.

Further, in the first opening portion 22a, the front rib 15a of the cover 15 engages with the inner protruding portions 25a on both sides in the first opening portion 22a. Similarly, in the third opening portion 22c, the side rib 15b of the cover 15 engages with the inner protruding portions 25a on both sides in the third opening portion 22c. Further, in the second opening portion 22b, the protruding portions 20b on right and left sides of the drive part 20 engage with the inner protruding portions 25a on both sides in the second opening portion 22b.

In addition, since the front rib 15a of the cover 15 is fitted into the gap between the two upper and lower base portions 26, the base portions 26 fitted into the gap between the upper and lower projecting flange portions 20c of the drive part 20 are interposed between the cover 15 and the drive part 20 in the up-down direction. In other words, the base portions 26 of the U-shaped elastic member 22 engage with (abut) the cover 15 and the drive part 20 in the up-down direction.

In addition, the protruding portions 25 at a plurality of positions on the outer circumferential portion of the base portion 26 are located between the cover 15 and the drive portion 20 in the front-rear direction or the right-left direction. Specifically, the plurality of protruding portions 25 provided on the outer circumferential portion of the base portion 26 engage with the cover 15 and the drive part 20 via the base portion 26 in the front-rear direction, and also engage with the cover 15 and the drive part 20 via the base portion 26 in the right-left direction.

In the structure described above, since the work machine 10 is provided with the U-shaped elastic member 22, the propagation of the vibration generated in the drive part 20 to the cover 15 in the up/down, front/rear, and right-left directions can be reduced. That is, the vibration propagated to the operator during processing is reduced, thereby improving the workability of the work machine 10. In the present embodiment, only the region close to the drive part 20 is provided with the U-shaped elastic member 22, and the elastic body is not provided on the region close to the motor 11. Therefore, the number of elastic bodies assembled to the work machine 10 can be reduced, and a cost of the work machine 10 can be reduced while the vibration of the work machine 10 can be reduced. In addition, according to the present embodiment, the motor portion 11 is not included in a vibration propagation route. Therefore, the vibration propagation route starts from only a front end portion of the housing 14, and a distance taken for the vibration propagation from the source of vibration to the grip part 14a on the rear side can be increased. In combination with the fact that the housing 14 is made of resin (and further the fact that the elastic portion for improving the grip performance is provided), the vibration propagated to the grip part 14a can be further reduced. Note that the vibration is also reduced in the case of gripping a portion around the motor 11, although not as much as around the grip part 14a.

Note that, in the work machine 10, up/down vibration is smaller than front/rear and right/left vibration. Therefore, since the hard base portions 26 of the U-shaped elastic member 22 are fitted into the gap between the upper and lower flange portions 20c of the drive part 20, up/down movement of the work machine 10 during processing can be easily controlled. That is, in the up-down direction, since the drive part 20 engages with the hard base portions 26 (having a high elastic modulus), the control is easy when the work machine 10 is moved in the up-down direction. That is, a region of the drive part 20 in the large vibration direction (the right-left direction or the front-rear direction) is supported by a soft elastic body (having a low elastic modulus) while a region of the drive part 20 in the small vibration direction (the up-down direction) is supported by a hard elastic body (having a high elastic modulus), and therefore, controllability and less vibration can be achieved. In addition, when the tip tool 52 is pressed in, the drive part 20 and the motor portion 11 are supposed to revolve around (pivot on) the vicinity of the intersection between the first axis A1 and the second axis B1 (at the support position of the drive part 20) (while taking the right-left direction as the revolution axis). However, since the drive part 20 engages with the hard base portions 26 (having a high elastic modulus), this movement can be suppressed, and therefore, the workability (controllability) can be improved. This revolution is mainly the up/down movement. In particular, the elastic body can suitably regulate this revolution because of including the first elastic body 23 and the second elastic body 24 arranged at different positions in the direction crossing the right-left direction.

In addition, since the cover 15 engages with the soft inner protruding portions 25a of the U-shaped elastic member 22 in the front-rear direction by using the front rib 15a and the side ribs 15b, the front/rear vibration can be effectively reduced.

In addition, the first elastic body 23 of the U-shaped elastic member 22 is located between the drive part 20 and the cover 15 in the front-rear direction, and engages with the drive part 20 and the cover 15. In other words, the first elastic body 23 of the U-shaped elastic member 22 is arranged on the front side of the drive part 20, and therefore, this arrangement is more effective for the front/rear vibration reduction in the work machine 10.

Note that the U-shaped elastic member 22 has the structure in which the right elastic body 27 and the left elastic body 28 are integrated via the first elastic body 23. Therefore, when the U-shaped elastic member 22 is assembled to the drive part 20, the U-shaped elastic member 22 only needs to be fitted into the outer circumferential portion of the drive part 20, and therefore, the easiness of the assembly of the work machine 10 can be improved. Further, the front/rear and the right/left vibration can be reduced by only the U-shaped elastic member 22 that is a single member, and therefore, the vibration can be reduced while the number of parts can be suppressed.

Next, a work machine 10 of a first modification example of the present embodiment will be described.

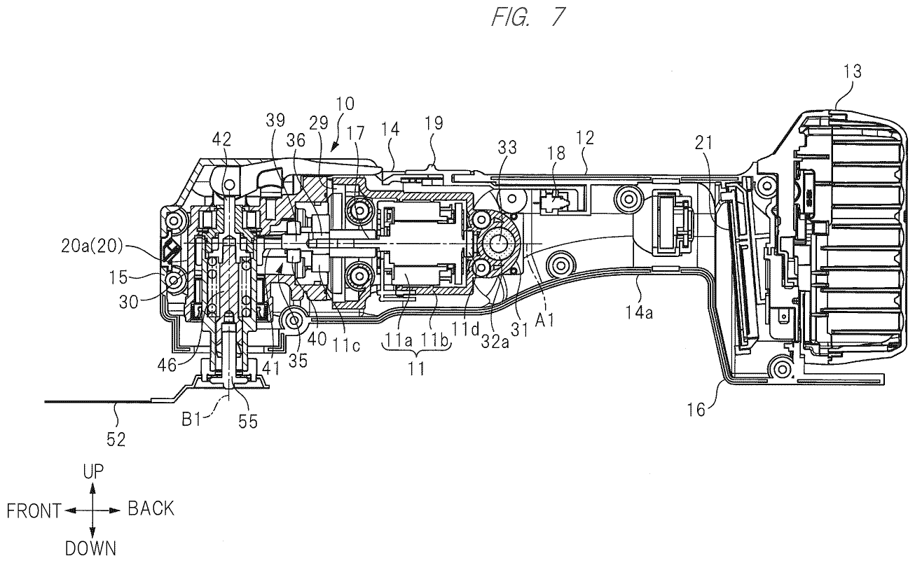

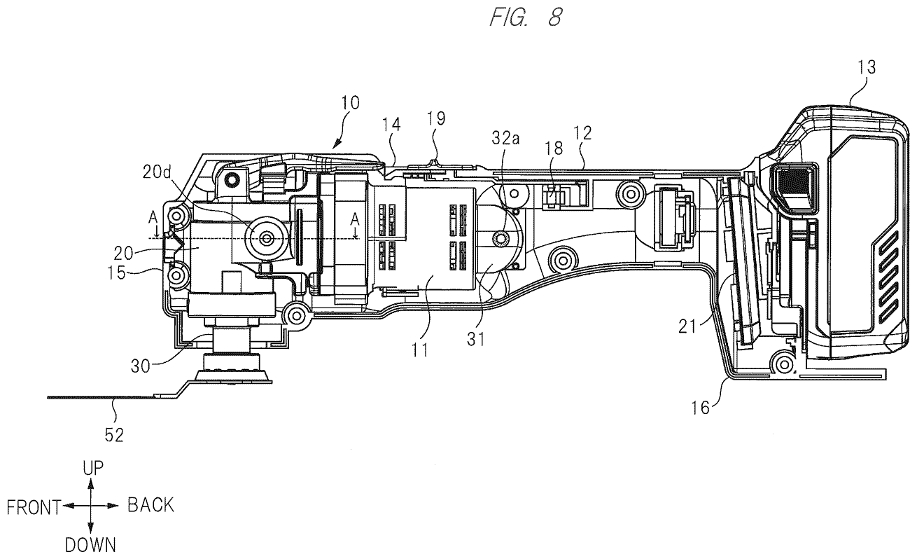

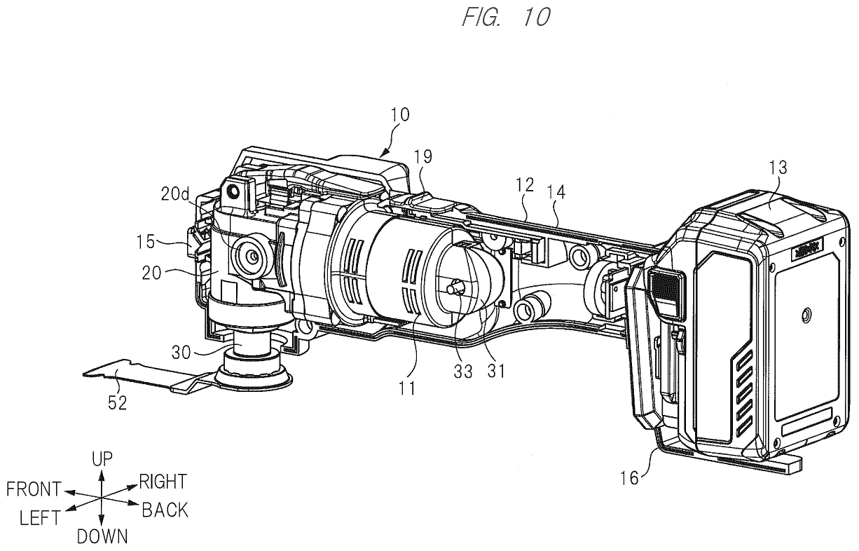

The work machine 10 of the first modification example shown in FIGS. 7 to 10 has a structure in which the region close to the motor portion 11 on the rear side is provided with an elastic body as a vibration reducing measure. The region close to the drive part 20 on the front side is not provided with an elastic body. That is, the drive part 20 and the cover 15 are connected not via an elastic body while the motor portion 11 and the housing 14 are connected via an elastic body. Specifically, an elastic body 32a is interposed between the motor portion 11 (the motor case 11b) and the housing 14 while the drive part 20 and the cover 15 are connected directly or via a different member (such as a resin material similar to the housing 14) having a larger rigidity than that of the elastic body 32a. Therefore, the number of elastic bodies can also be reduced in the first modification example, as similar to the embodiment described above. A concave portion 20d is formed on a side surface of the drive part 20, and a convex portion 14d formed on the housing 14 is engaged with (fitted into) this concave portion 20d, thereby non-elastically connecting the drive part 20 and the housing 14. In the present embodiment, the concave portion 20d is a different body from the drive part 20, and is fixed to the drive part 20 by an adhering means. The concave portion 20d is made of resin which is a material similar to the housing 14. The convex portion 14d is formed on an inner wall of the housing 14, and has a structure integrated with the housing 14 so as not detachable therefrom. A gap particularly in the front-rear direction is formed between the concave portion 20d and the convex portion 14d, and this gap enables the inner part to move relative to the housing 14 in the front-rear direction. Further, this gap enables the inner part (the drive unit made of the drive part 20 and the motor 11) to slightly swing relative to the housing 14 while taking the position of the concave portion 20d as the pivot point. In the inner part, this enables the rear end portion to swing in the up/down or the right-left direction (simultaneously, to move the front end portion in the opposite direction) while taking the concave portion 20d as the pivot point. The concave portion 20d may be formed integrally with the drive part 20.

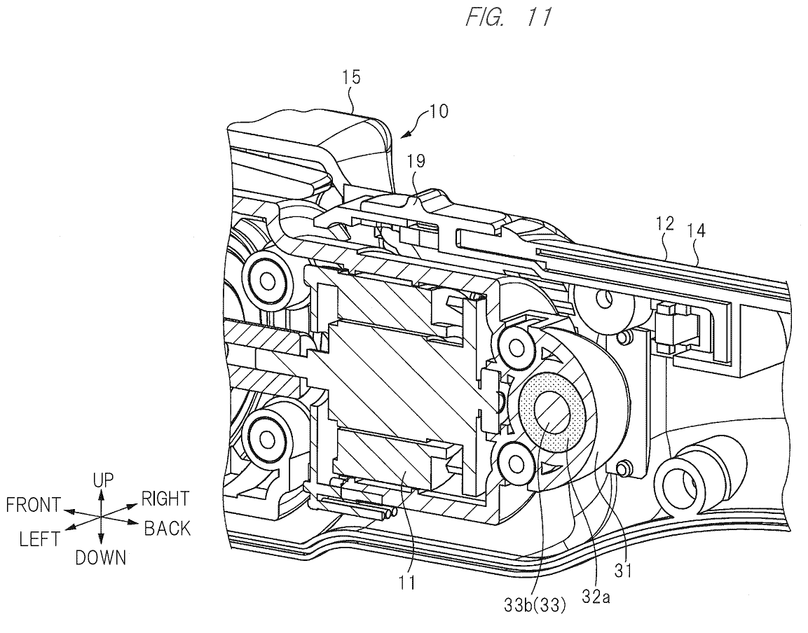

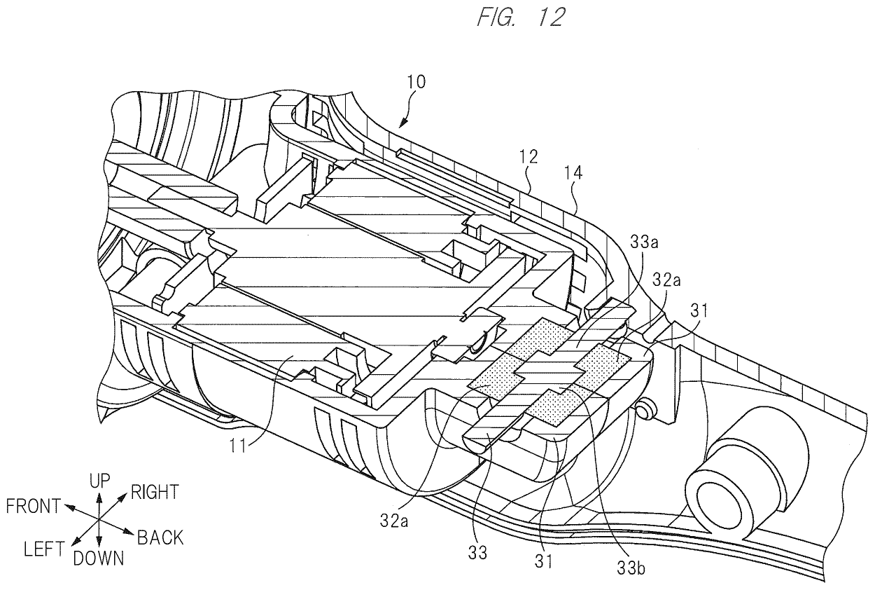

In the work machine 10 of the first modification example, the motor case 11b has a rear extending portion 31 extending rearward from the rear end of the motor 11, and the elastic body 32a is interposed between the rear extending portion 31 and the housing 14. As shown in FIGS. 11 and 12, the annular elastic body 32a is fitted into the rear extending portion 31 of the motor 11. Further, a shaft 33 is fitted into a hole portion of the annular elastic body 32a. A central portion of the shaft 33 is a large diametrical portion 33b having a large diameter, and right and left portions on both sides of the large diametrical portion 33b are small diametrical portions 33a having a smaller diameter than the large diametrical portion 33b. And, both ends of the shaft 33 engage with the inner wall of the housing 14 to be supported by the housing 14. That is, the motor portion 11 is supported by the housing 14 via the annular elastic body 32a and the shaft 33.

In the work machine 10 of the first modification example, since the rear of the motor case 11b is provided with the rear extending portion 31, a portion (a portion close to the rear of the electric motor 11a) distant from a center of vibration in the drive part 20 or the like can be supported via the elastic body 32a. Thereby, the up/down, the right/left, and the front/rear vibration can be reduced. In more detail, in the case of the vibration on the inner part during driving, when the rear portion of the inner part moves relative to the housing 14 in the up/down and right-left direction while taking the concave portion 20d as the pivot point, or when the inner part moves relative to the housing 14 in the front-rear direction, the elastic body 32a can elastically deform, thereby cancel out the vibration of the inner part. Since the large diametrical portion 33b of the shaft 33 engages with the elastic body 32a, the vibration particularly in the right-left direction can be reduced more effectively. In addition, the rear extending portion 31 is provided at the rear of the motor case 11b, and the motor portion 11 is supported via the elastic body 32a in this rear extending portion 31, and therefore, the supporting structure around the motor can be made compact, and, a space can be secured, and therefore, a soft elastic body can also be used.

Note that structures of the annular elastic body 32a and the case of the electric motor 11a are a half-and-half body structure that is dividable to the right and left sides. Therefore, when the left and right cases are assembled, in advance, in one case in which the elastic body 32a of one half of the half-and-half body structure is assembled to the rear extending portion 31, the shaft 33 is fitted into the hole portion of the elastic body 32a. After that, the other case in which the elastic body 32a of the other half of the half-and-half body structure is assembled. Thereby, the cases can be assembled with the elastic body 32a and the shaft 33 attached.

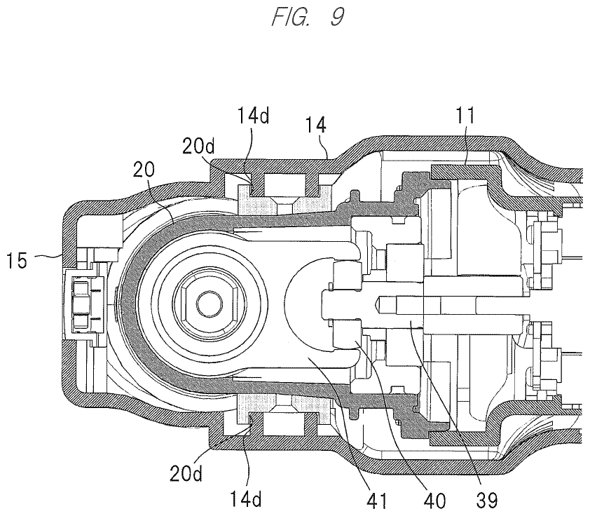

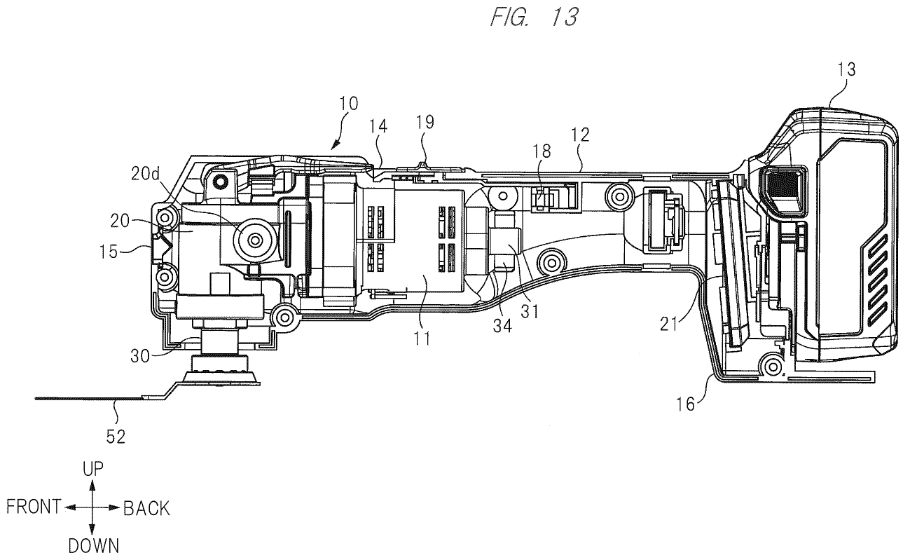

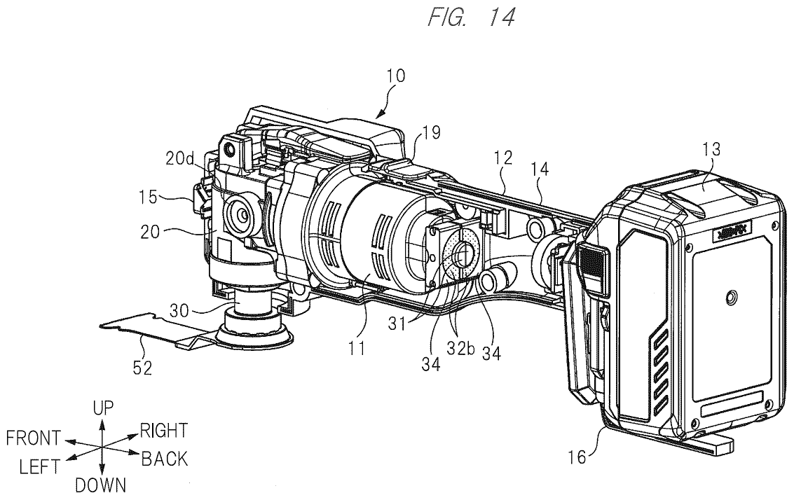

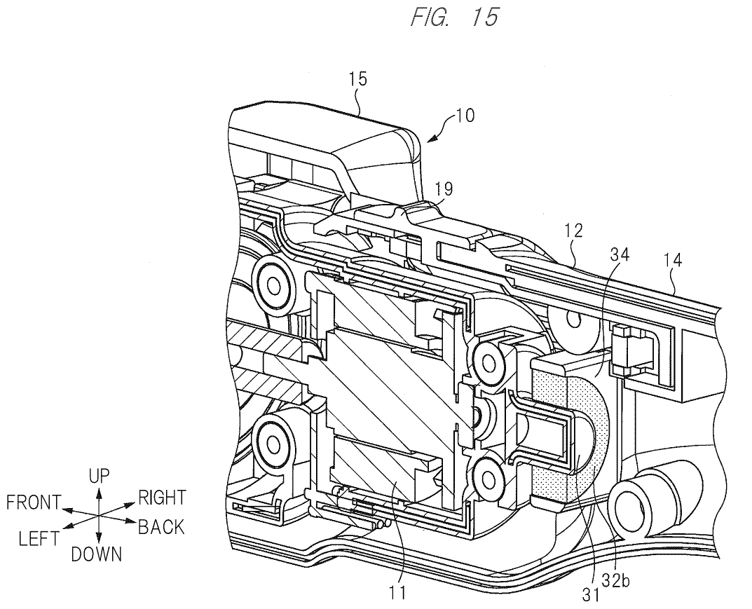

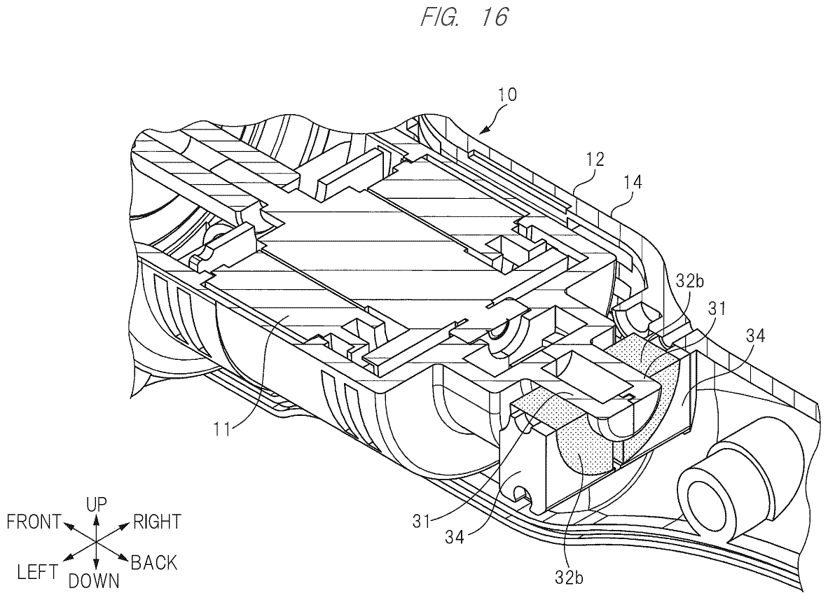

In addition, a work machine 10 of a second modification example shown in FIGS. 13 and 14 also has the structure in which the region close to the electric motor 11a on the rear side is provided with the elastic body as the vibration reducing means. A structure of engagement between the concave portion 20d and the convex portion 14d is similar to that of the first modification example (FIG. 9). Also in the work machine 10 of the second modification example, the motor portion 11 has the rear extending portion 31 extending rearward from the rear end of the motor case 11b, and the elastic body 32b is interposed between the rear extending portion 31 and the housing 14. As shown in FIGS. 15 and 16, the semicircular elastic body 32b is fitted to the rear extending portion 31 of the motor 11. The semicircular elastic body 32b is held by an engaging member 34, and is supported by the housing 14 since this engaging member 34 engages with the inner wall of the housing 14. That is, the motor portion 11 is supported by the housing 14 via the semicircular elastic body 32b and the engaging member 34. Note that the shape of the elastic body 32b may be achieved by not the semicircular shape but a single circular shape.

Also in the work machine 10 of the second modification example, since the rear of the motor portion 11 is provided with the rear extending portion 31, a portion (a portion close to the rear of the electric motor 11a) distant from a center of vibration in the drive part 20 or the like can be supported via the elastic body 32b. Thereby, the up/down, the right/left, and the front/rear vibration can be reduced.

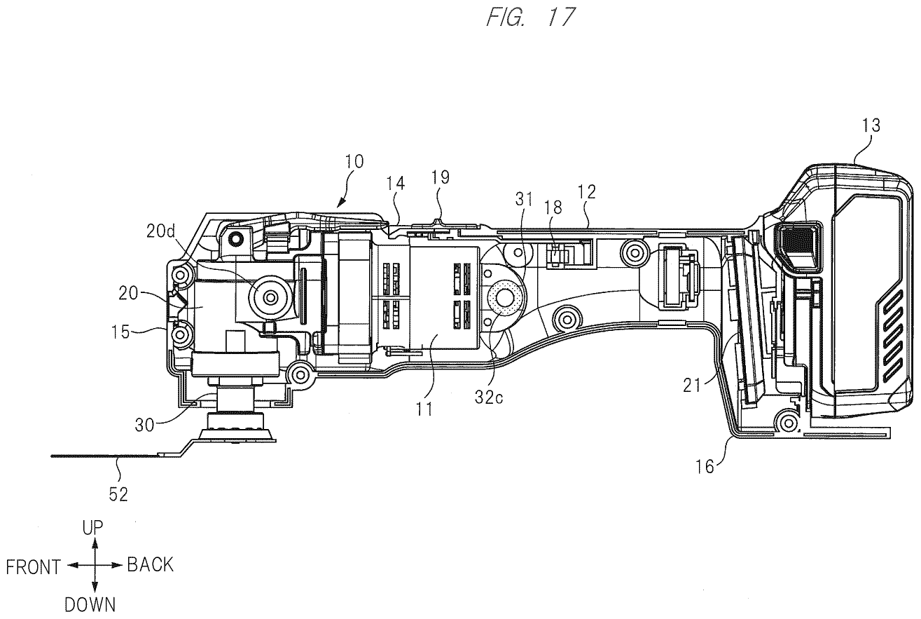

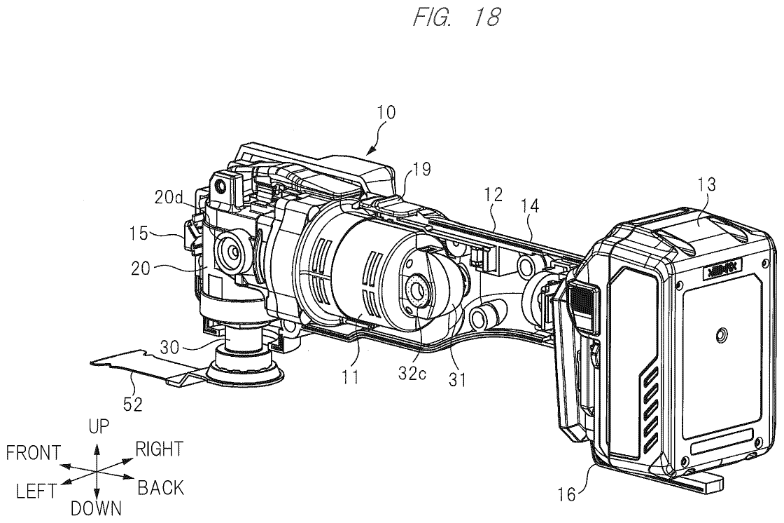

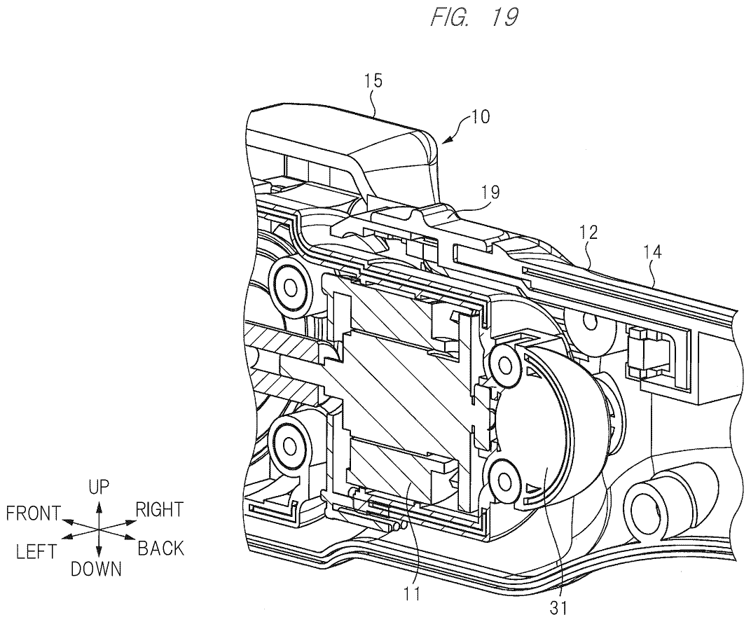

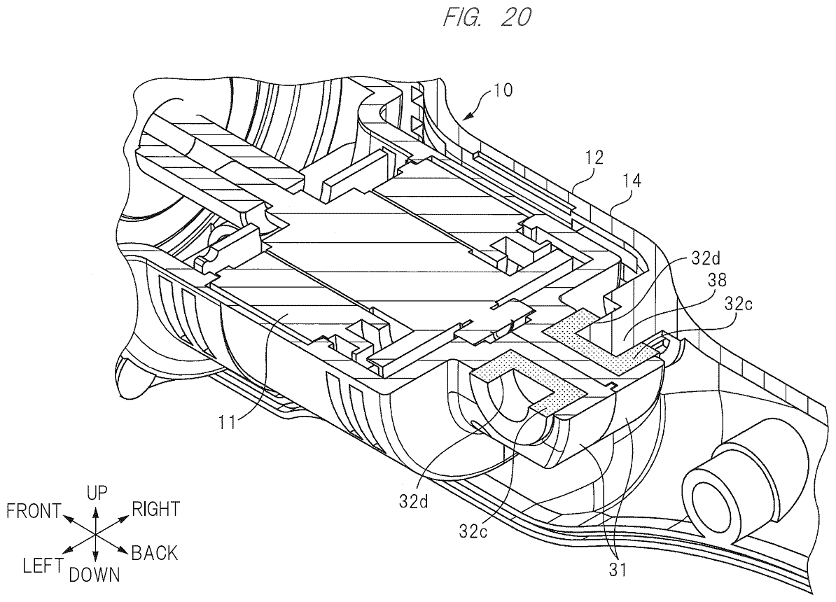

In addition, a work machine 10 of a third modification example shown in FIGS. 17 and 18 also has the structure in which the region close to the motor portion 11 on the rear side is provided with the elastic body as the vibration reducing means. A structure of engagement between the concave portion 20d and the housing 14 is similar to that of the first modification example (FIG. 9). Also in the work machine 10 of the third modification example, the motor portion 11 has the rear extending portion 31 extending rearward from the rear end of the motor 11, and the elastic body 32c is interposed between the rear extending portion 31 and the housing 14. As shown in FIGS. 19 and 20, the circular elastic body 32c is fitted to the rear extending portion 31 of the motor 11. The circular elastic body 32c has a concave portion 32d, and is supported by the housing 14 since a protruding supporting portion 38 protruding from the inner wall of the housing 14 engages with the concave portion 32d of this elastic body 32c. That is, the motor portion 11 is supported by the housing 14 via the circular elastic body 32c and the protruding supporting portion 38.

Also in the work machine 10 of the third modification example, since the rear of the motor portion 11 is provided with the rear extending portion 31, a portion (a portion close to the rear of the motor 11) distant from a center of vibration in the drive part 20 or the like can be supported via the elastic body 32c. Thereby, the up/down, the right/left, and the front/rear vibration can be reduced. In addition, since the protruding supporting portion 38 engaging with the elastic body 32c is provided integrally with the inner wall of the housing 14, the number of parts to be interposed can be reduced.

The present invention is not limited to the embodiments described above, and various modifications can be made within the scope of the present invention. For example, the above-described embodiments have been explained while exemplifying the U-shaped elastic member 22 having the first elastic body 23 and the second elastic body 24 integrated as the elastic body. However, the first elastic body 23 and the second elastic body 24 may be separate bodies. Further, the protruding portion (the first elastic body) 25 and the base portion (the second elastic body) 26 may also be separate bodies. For example, the protruding portion 25 and the base portion 26 may be separate rubbers, and may be overlapped on each other.

In addition, the U-shaped elastic member 22 may be assembled to not the drive part 20 but the rear end of the case of the electric motor 11a.

### EXPLANATION OF REFERENCE CHARACTERS

10 . . . Work machine, 11 . . . Motor, 11a . . . Electric motor, 12 . . . Machine body, 13 . . . Battery pack, 14 . . . Housing (Outer housing), 15 . . . Cover (Housing, Outer housing), 15a . . . Front rib, 15b . . . Side rib, 16 . . . Mount part, 17 . . . Motor shaft, 18 . . . Main switch, 19 . . . Slide switch, 20 . . . Drive part (Head part), 20a . . . Drive part case, 20b . . . Protruding portion, 20c . . . Flange portion, 21 . . . Controller, 22 . . . U-shaped elastic member (Elastic body), 23 . . . First elastic body, 24 . . . Second elastic body, 25 . . . Protruding portion (First elastic portion), 25a . . . Inner protruding portion, 26 . . . Base portion (Second elastic portion), 27 . . . Right elastic body, 28 . . . Left elastic body, 29 . . . Holder, 30 . . . Output shaft, 31 . . . Rear extending portion, 32a, 32b, 32c . . . Elastic body, 32d . . . Concave portion, 33 . . . Shaft, 33a . . . Small diametrical portion, 33b . . . Large diametrical portion, 34 . . . Engaging member, 35 . . . Power transmission mechanism, 36 . . . Spindle, 38 . . . Protruding supporting portion, 39 . . . Eccentric shaft, 40 . . . Ball bearing, 41 . . . Swing arm, 42 . . . First shaft, 46 . . . Second shaft, 52 . . . Tip tool, 55 . . . Tool fixing member, A1 . . . First axis, B1 . . . Second axis

1. A work machine comprising:
a drive unit including a motor, and a drive part arranged on a front rear side of the motor and fixed to the motor;
an output shaft supported by the drive part and extending in an up-down direction; and
a housing accommodating the motor,
wherein the drive unit is supported by the housing in a state in which the drive part and the housing are connected via an elastic body and the motor and the housing are not connected.

2. A work machine comprising:
a drive unit including a motor, and a drive part arranged on a front rear side of the motor and fixed to the motor;
an output shaft supported by the drive part; and
a housing accommodating the motor,
wherein the drive unit is supported by the housing in a state in which the drive part and the housing are inelastically connected and the motor and the housing are connected via the elastic body.

3. The work machine according to claim 1,
wherein the elastic body includes a first elastic body and a second elastic body arranged at different positions in a direction crossing a right-left direction.

4. The work machine according to claim 3,
wherein the first elastic body and the second elastic body are arranged at different positions in a front-rear direction.

5. The work machine according to claim 3,
wherein either one of the first elastic body and the second elastic body includes:
a first elastic portion having a first elastic modulus and connected to either one of the housing and the drive part; and
a second elastic portion having a second elastic modulus higher than the first elastic modulus and connected to the other of the housing and the drive part.

6. The work machine according to claim 5,
wherein the second elastic portion is interposed between the housing and the drive part in the up-down direction.

7. The work machine according to claim 5,
wherein the first elastic portion is located between the housing and the drive part in a front-rear direction or the right-left direction.

8. The work machine according to claim 1,
wherein the elastic body is located between the drive part and the housing in a front-rear direction.

9. The work machine according to claim 1,
wherein the elastic body includes:
a left elastic body arranged on a left side of the drive part; and
a right elastic body arranged on a right side of the drive part, and
the left elastic body and the right elastic body are integrated.

10. The work machine according to claim 1,
wherein the elastic body is a U-shaped elastic member, and
the U-shaped elastic member includes respective portions arranged on a left side, a right side, and a front side of the drive part.

11. The work machine according to claim 2,
wherein the drive part and the housing are connected directly or via a member having a larger rigidity than the elastic body, and
the elastic body is interposed between the motor and the housing.

12. The work machine according to claim 10,
wherein the motor has a rear extending portion extending rearward from a rear end of the motor, and
the elastic body is interposed between the rear extending portion and the housing.

13. A work machine comprising:
a drive unit including a motor, and a drive part arranged on a front side of the motor and fixed to the motor;
an output shaft supported by the drive part and extending in an up-down direction;
a housing accommodating the motor; and
an elastic body arranged to be closer to the front side than the driver,
wherein the drive part and the housing are connected via the elastic body in a front-rear direction.

14. The work machine according to claim 13,
wherein the elastic body has a U shape, and
the drive part and the housing are connected via the elastic body in a right-left direction.
